(19) United States
(12) Patent Application Publication
(10) Pub. No.: US 2015/0100449 A1
(43) Pub. Date: Apr. 9, 2015

(54) SYSTEMS AND METHODS FOR ELECTRONIC AUCTIONS WITH A SET NUMBER OF BIDDERS

(71) Applicant: Crisostomo Bautista Garcia, Rancho Santa Fe, CA (US)

(72) Inventor: Crisostomo Bautista Garcia, Rancho Santa Fe, CA (US)

(21) Appl. No.: 14/509,906

(22) Filed: Oct. 8, 2014

Related U.S. Application Data
(60) Provisional application No. 61/888,602, filed on Oct. 9, 2013.
(60) Provisional application No. 61/899,770, filed on Nov. 4, 2013.
(60) Provisional application No. 61/909,923, filed on Nov. 27, 2013.
(60) Provisional application No. 61/919,615, filed on Dec. 20, 2013.

(51) Int. Cl. G06Q 30/08

(52) U.S. Cl. CPC G06Q 30/08
USPC 705/26.3

(57) ABSTRACT

An electronic auction server may be configured such that winners of an electronic auction session can obtain a bid item for less than the cost of buying the bid item on the open market (by paying a marketplace acquisition price). The electronic auction server can be configured to initiate an electronic auction session among a predetermined set number of bidder accounts after each bidder account of the set number of bidder accounts has committed to the electronic auction session. Also, upon initiation of the electronic auction session, a bid price is set to an initial bid price and each bidder account is debited for an entry price upon initiating of the electronic auction session and ascribed with a start quantity of bids.

### CROSS-REFERENCE TO RELATED APPLICATIONS

The present application claims priority to provisional U.S. Application Ser. No. 61/888,602, entitled “METHODS FOR FAST AUCTIONS OF ANY ITEM FOR SALE ON THE INTERNET AT DISCOUNTED PRICES”, filed Oct. 9, 2013, provisional U.S. Application Ser. No. 61/899,770, entitled “SYSTEMS AND METHODS FOR ELECTRONIC AUCTIONS WITH A SET NUMBER OF BIDDERS”, filed Nov. 4, 2013, provisional U.S. Application Ser. No. 61/909,923, entitled “SYSTEMS AND METHODS FOR ELECTRONIC AUCTIONS WITH A SET NUMBER OF BIDDERS”, filed Nov. 27, 2013 and provisional U.S. Application Ser. No. 61/919,615, entitled “SYSTEMS AND METHODS FOR ELECTRONIC AUCTIONS WITH A SET NUMBER OF BIDDERS”, filed Dec. 20, 2013, each of which are hereby expressly incorporated herein by reference in its entirety.

### FIELD

The present disclosure relates generally to electronic commerce and in particular to electronic auctions with a set number of bidders.

### BACKGROUND

Traditional electronic auctions included the sale of a bid item, such as a good or service, from a process of taking bids from bidders and selling the bid item to the highest bidder. These electronic auctions are typically open to an arbitrarily large body of bidders over a network, such as but not limited to the Internet.

### SUMMARY

The systems, methods, devices, and computer program products discussed herein each have several aspects, no single one of which is solely responsible for its desirable attributes. Without limiting the scope of this invention as expressed by the claims which follow, some features are discussed briefly below. After considering this discussion, and particularly after reading the section entitled “Detailed Description,” it will be understood how advantageous features of this invention include improved efficiency when introducing devices on a medium.

One aspect of the subject matter described in the disclosure provides method for electronic auctions using an auction server. The method comprises initiating an electronic auction session among a predetermined set number of bidder accounts after each bidder account of the set number of bidder accounts has committed to the electronic auction session. The method further comprises debiting each bidder account for an entry price upon the initiating of the electronic auction session. The method further comprises setting a bid price to an initial bid price upon the initiating of the electronic auction session. The method further comprises monitoring a timer for an elapsed time. The method further comprises ending the electronic auction session upon an achievement of the elapsed time.

One aspect of the subject matter described in the disclosure provides a system for electronic auctions. The system comprises an auction database configured to store at least one bidder account. The system further comprises an auction server configured to maintain the auction database. The auction server is further configured to initiate an electronic auction session among a predetermined set number of bidder accounts after each bidder account of the set number of bidder accounts has committed to the electronic auction session. Also, upon initiation of the electronic auction session, a bid price is set to an initial bid price and each bidder account is debited for an entry price upon initiating of the electronic auction session and ascribed with a start quantity of bids.

One aspect of the subject matter described in the disclosure provides a method for electronic auctions using an auction server. The method comprises initiating an electronic auction session among a predetermined set number of bidder accounts after each bidder account of the set number of bidder accounts has committed to the electronic auction session. The method further comprises debiting each bidder account for an entry price upon the initiating of the electronic auction session. The method further comprises ascribing each bidder account with a start quantity of at least one bid upon the commitment to the electronic auction session. The method further comprises recording a bid price for each bid used. The method further comprises monitoring a timer for an elapsed time. The method further comprises initiating the electronic auction session upon an achievement of the elapsed time.

One aspect of the subject matter described in the disclosure provides a method for electronic auctions. The method comprises sending a commitment message for a first bidder account associated with a bidder device from the bidder device to an auction server hosting an electronic auction session. The commitment message configures the auction server to add the first bidder account to a predetermined set number of bidder accounts. The electronic auction session is configured to initiate after each bidder account of the set number of bidder accounts has committed to the electronic auction session. The method further comprises sending a debit message for the first bidder account from the bidder device to the auction server. The debit message configures the auction server to debit real world currency from the first bidder account in accordance with an entry price upon the initiating of the electronic auction session. The auction server is configured to debit each bidder account by the entry price upon the initiating of the electronic auction session. The method further comprises receiving a start quantity of bids message for the first bidder account at the bidder device from the auction server. The start quantity of bids message comprises information concerning a start quantity of at least one bid ascribed to each bidder account upon commitment to the electronic auction session. The method further comprises receiving an initiation notification message for the first bidder account at the bidder device from the auction server, wherein the initiation notification message indicates that the electronic auction session is initiated upon achievement of an elapsed time.

### BRIEF DESCRIPTION OF THE DRAWINGS

FIG. 1 is a network diagram illustrating an electronic auction system in accordance with an exemplary embodiment.

FIG. 2 is a flow chart of an electronic auction process that can be implemented in the electronic auction system of FIG. 1 in accordance with an exemplary embodiment.

FIG. 3 is a flow chart of a process of setting up the electronic auction session of FIG. 2 in accordance with an exemplary embodiment.

FIG. 4 is a flow chart of a process of executing the electronic auction session of FIG. 2 in accordance with an exemplary embodiment.

FIG. 5 is a flow chart of a process of purchasing additional bids in the electronic auction system of FIG. 1 in accordance with an exemplary embodiment.

FIG. 6 is a flow chart of a process of initiating an overflow electronic auction session in the electronic auction system of FIG. 1 in accordance with an exemplary embodiment.

FIG. 7A is a screenshot of a bid item with a listing of a marketplace acquisition price for the bid item implementable in the electronic auction system of FIG. 1 in accordance with an exemplary embodiment.

FIG. 7B is a screenshot of a notice for an electronic auction session that can be implemented in the electronic auction system of FIG. 1 in accordance with an exemplary embodiment.

FIG. 7C is a screenshot of a user interface at electronic auction session initiation of the electronic auction session of FIG. 7B.

FIG. 7D is a screenshot of a user interface for the electronic auction session of FIG. 7B 12 seconds after initiation of the electronic auction session.

FIG. 7E is a screenshot of a user interface for the electronic auction session of FIG. 7B 19 seconds after initiation of the electronic auction session.

FIG. 7F is a screenshot of a user interface for the electronic auction session of FIG. 7B 21 minutes and 35 seconds after initiation of the electronic auction session.

FIG. 8A is a screenshot of a notice from another version of an electronic auction session that can be implemented in the electronic auction system of FIG. 1 but that differs from the electronic auction session of FIGS. 7A to 7F by the number of bidder accounts committed to the electronic auction session and type of the bid increment in accordance with an exemplary embodiment.

FIG. 8B is a screenshot of a user interface at electronic auction session initiation of the electronic auction session of FIG. 8A.

FIG. 8C is a screenshot of a user interface for the electronic auction session of FIG. 8A 5 seconds after initiation of the electronic auction session.

FIG. 8D is a screenshot of a user interface for the electronic auction session of FIG. 8A 12 seconds after initiation of the electronic auction session.

FIG. 8E is a screenshot of a user interface for the electronic auction session of FIG. 8A 10 minutes and 35 seconds after initiation of the electronic auction session.

FIG. 9A is a screenshot of a notice from another version of an electronic auction session that can be implemented in the electronic auction system of FIG. 1 but that differs from the electronic auction session of FIGS. 8A to 8E with a different achievement of an elapsed time that ends an electronic auction session in accordance with an exemplary embodiment.

FIG. 9B is a screenshot of a user interface at the initiation of the electronic auction session of FIG. 9A.

FIG. 9C is a screenshot of a user interface for the electronic auction session of FIG. 9A 1 hour, 26 minutes and 19 seconds after the auction start window.

FIG. 9D is a screenshot of a user interface for the electronic auction session of FIG. 9A 1 hour, 26 minutes and 26 seconds after the auction start window.

FIG. 9E is a screenshot of a user interface for the electronic auction session of FIG. 9A at the end of the auction.

FIG. 10 is a screenshot of an invitation to join a customized electronic auction session that can be implemented in the electronic auction system of FIG. 1 in accordance with an exemplary embodiment.

FIG. 11 is a screenshot of a user interface of a unique bid electronic auction session that can be implemented in the electronic auction system of FIG. 1 in accordance with an exemplary embodiment.

The various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

The detailed description set forth below in connection with the appended drawings is intended as a description of exemplary embodiments and is not intended to represent the only embodiments which may be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments. In some instances, some devices are shown in block diagram form.

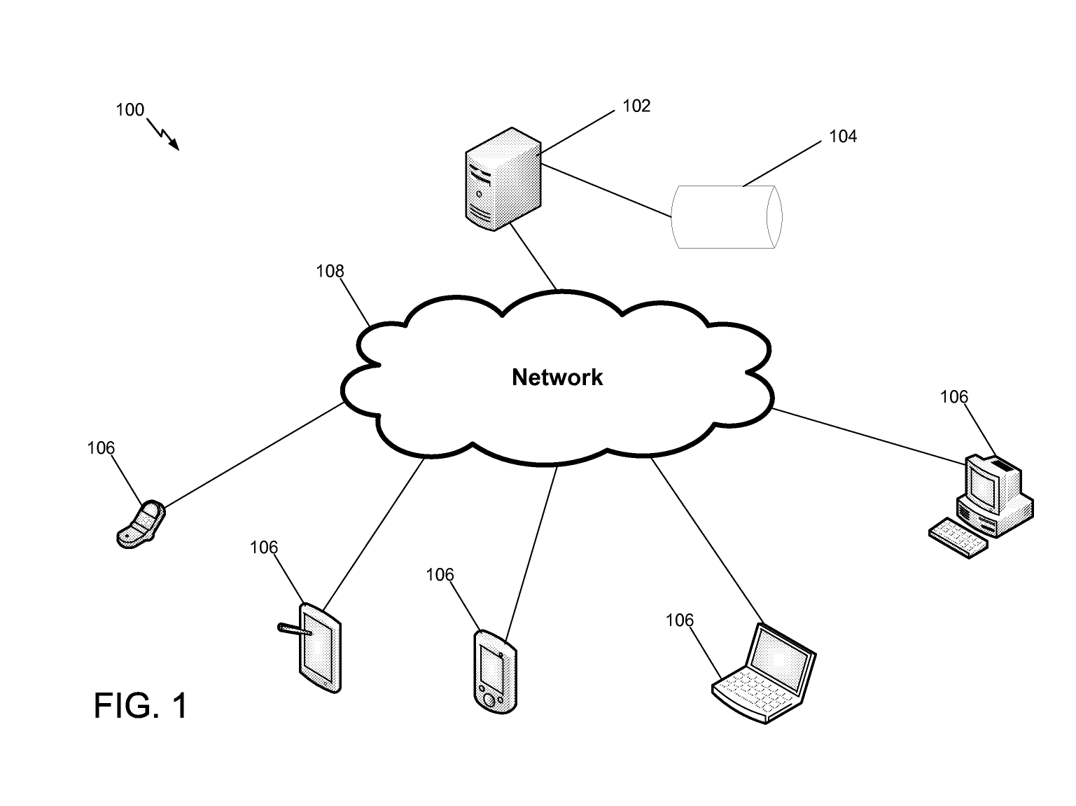

FIG. 1 is a network diagram illustrating an electronic auction system in accordance with an exemplary embodiment. The electronic auction system 100 includes a number of bidder devices 106 which can interact with a bidder via a user interface presented by each bidder device 106. The interactions via a user interface can be associated with a bidder account. Each of the bidder devices can be connected to a network 108, such as but not limited to the Internet. The bidder devices 106 can include any network connected device capable of communicating over a network such as, but not limited to, a computer, laptop, personal digital assistant, tablet computer or smartphone.

The electronic auction system 100 can also include an auction server 102. The auction server 102 can maintain an auction database 104. The auction database 104 can include, but is not limited to, a relational database. The auction server 102 can communicate with each of the bidder devices 106 over the network 108. The auction server 102 can also store the bidder accounts in the auction database 104. The bidder accounts can be centrally maintained by the auction server 102 such that updates to the bidder accounts in the auction database 104 can be accordingly communicated to the bidder devices 106 for presentation via the user interface of the bidder devices 106. Thereby, in executing processes related to an electronic auction, the auction server 102 can update the bidder accounts in the auction database 104, which in turn is presented to each bidder via the user interface of a bidder device 106 associated with the updated bidder account.

In certain embodiments, the electronic auction system 100 can execute an electronic auction session with participation limited to a set number of bidder accounts. The set number of bidder accounts can be predetermined prior to set up of an electronic auction session 100 or prior to initiation of the electronic auction session 100. By limiting the electronic auction session to a set number of bidder accounts, an electronic auction session can be performed and supervised in a manner more efficient than an electronic auction session not limited to a set number of bidder accounts. The electronic auction session can be limited to the set number of bidders as a condition of starting the electronic auction session.

Systems and methods can be structured such that winners of an electronic auction session can obtain a bid item for less than the cost of buying the bid item on the open market (by paying a marketplace acquisition price). In specific embodiments, the electronic auction session 100 can include a rule where an entry price multiplied by a set number of bidder accounts (plus optionally an initial bid price) is greater than (or, optionally, equal to) a marketplace acquisition price of a bid item. In additional embodiments, the electronic auction session 100 can include a rule where the entry price multiplied by the set number of bidder accounts plus the initial bid price plus a bid increment multiplied by the total number of bids ascribed is greater than (or, optionally, equal to) the marketplace acquisition price of the bid item of the electronic auction session. The entry price can be a charge assessed of each bidder for participating in the electronic auction session. Thus, the entry price can be a price charged to a bidder account in order for the bidder account to be a participant in the electronic auction session. In certain embodiments, entry prices for several different electronic auction sessions can be presented in a user interface as a graduated schedule of entry prices to present options and enticements for a bidder to commit to a particular electronic auction session. The initial bid price can be a price of an initial bid upon initiation of the electronic auction session and from where all subsequent bid prices build from. The bid prices can be increased by a bid increment upon use of a bid. The marketplace acquisition price of a bid item is a price associated with the bid item that can be determined by a survey of a marketplace (such as but not limited to an electronic marketplace from a search over the Internet), a price for a purchaser in a retail or wholesale transaction, an appraisal of the fair market value of the bid item, a reserve price of the owner of the bid item or an arbitrary price associated with the bid item. In certain embodiments the marketplace acquisition price is a marketplace price of the bid item. In specific embodiments, the marketplace acquisition price is less than a price of the bid item. Thereby, each of the entry price and initial bid price can be scaled to be interrelated with the set number of bidder accounts and the marketplace acquisition price of a bid item. In certain embodiments, the entry price and bid price charged to a bidder account may be used towards purchase of the bid item.

In select embodiments, a bid item can be any item (product or service) that can be sold in a market irrespective of price or place of sale (such as but not limited to an online marketplace or a brick and mortar store). Although the term marketplace acquisition price is used, different standards of valuation for a bid item can be used as the marketplace acquisition price in different embodiments. By participating in an electronic auction session described herein, a bidder account can acquire the bid item at a price lower than the marketplace acquisition price of the bid item. A bidder account that wins an electronic auction session can also receive the difference between the marketplace acquisition price of a bid item won and the initial bid price. This difference can be in real world currency or credit within the context of the electronic auction session.

In particular embodiments, an auction server can monitor the activities of a bidder account and/or a bidder device associated with a bidder account. The activities of the bidder account can be monitored to determine whether there is any undesired behavior by the bidder account such as (but not limited to) cheating or collusion among different bidder accounts. For example, a record of the bidder accounts that participated in a previous electronic auction session can be recorded to determine whether any two (or more) bidder accounts have previously participated in a common electronic auction session and how many times the two (or more) bidder accounts have out bid the other. Furthermore, the user interface of a bidder device can present information concerning other bidder accounts such as but not limited to the number of times a bidder account has been a winner or the number of times that a bidder account has participated in an electronic auction session.

In certain embodiments, a bidder account that participates in an electronic auction session without being a winner can lose (be debited) only a small but fixed amount through the course of participation in the electronic auction session. In particular embodiments, each bidder account that is not a winner can receive a percentage of the revenues from purchase of any additional bids. Also, each bidder account can receive a percentage of the difference between the bid price of the winning bid and the initial bid price. In particular embodiments, revenues made for the operator of an electronic auction session can be capped such that the operator of the electronic auction session can make only a percentage (e.g., about 2%, 3%, 4%, 5%, 6%, 7%, 8%, 9%, 10%, 11%, 12%, 13%, 14%, 15%, 16%, 17%, 18%, 19%, 20% or more) of the marketplace acquisition price of a bid item with the remainder from the electronic auction session rebated back among each bidder account that is not a winner. In specific embodiments, the entry price multiplied by the set number of bidder accounts committed to the electronic auction session can be capped at a particular percentage of the marketplace acquisition price of a bid item (such as but not limited to being capped at less than 50%, 55%, 60%, 65%, 70%, 75% or 80%).

An electronic auction session can be performed in a short amount of time (such as but not limited to less than 5, 10, 15, 20, 25, 30, 35, 40 or 45 minutes). This can be by virtue of one or more aspects of an electronic auction session, including but not limited to limiting an electronic auction session to be performed among a set number of bidder accounts, ending an electronic auction session based upon a consistent achievement of an elapsed time throughout the electronic auction session (such as but not limited to an elapse of 5, 6, 7, 8, 9, 10, 11, 12, 13, 14, 15, 16, 17, 18, 19, or 20 seconds irrespective of the progress of the electronic auction session), a high initial bid price or a high bid increment. In certain embodiments, an electronic auction session can be performed quickly by making bid increments high when calculated as a percent of the marketplace acquisition price of a bid item (such as but not limited to 0.3% to 10% of the marketplace acquisition price) with the purchased bid price at a multiple of the bid increment (such as but not limited to 1×, 1.5×, 2×, 2.5×, 3×, 3.5×, 4×, 4.5×, or 5× the bid increment).

In particular embodiments, electronic auction sessions can be linked in a manner in which a current electronic auction session precludes a winner of a previous electronic auction session from joining the current electronic auction session. In further embodiments, losers of the previous electronic auction session can have a limited period of time in which to join a current electronic auction session that precludes the winner of the previous electronic auction session from joining.

In certain embodiments, fees for an operator of an electronic auction session can be capped to a percentage of the marketplace acquisition price of the bid item. In additional embodiments, an entry price and/or a start quantity of bids ascribed to a bidder account of the electronic auction session can be free for preferred bidder accounts to incentivize commitments from preferred bidder accounts to the electronic auction session.

In numerous embodiments, parameters of an electronic auction session can be customized (as a customized electronic auction session) by a bidder account (as a customizing bidder account). These parameters can be any variable aspect of the customized electronic auction session, such as but not limited to an entry price and the set number of bidder accounts required to commit to the customized electronic auction session to initiate the customized electronic auction session. In particular embodiments, the customizing bidder account can customize parameters of the customized electronic auction session that other bidder accounts can commit to. In further embodiments, the customizing bidder account can commit to the customized electronic auction session with parameters customized by the customizing bidder account. In additional embodiments, the parameters of the customized electronic auction session can be customized by the customizing bidder account by the customizing bidder account committing to the customized electronic auction session (such as but not limited to where the entry price of the customized electronic auction session decreases with more commitments from customizing bidder accounts). The customized electronic auction session can also be initiated when a sufficient number of other bidder accounts (including other customizing bidder accounts) commits to the customized electronic auction session. In a number of embodiments, the operator of the customized electronic auction session can provide a number of customization options for a customizing bidder account to choose from, such as but not limited to where the entry price and the set number of bidder accounts required to commit to the customized electronic auction session to initiate the customized electronic auction session. In certain embodiments, the entry price and the set number of bidder accounts required to commit to the customized electronic auction session to initiate the customized electronic auction session are inversely related.

In particular embodiments, an electronic auction session can be executed where each bidder account can set a bid price for each bid used (as a unique bid electronic auction session). The winning bid within the unique bid electronic auction session can be the bid with a bid price that satisfies a particular condition, such as (but not limited to) being the highest unique bid price below a maximum bid price (“highest unique bid”), second highest unique bid price, lowest unique bid price above a minimum bid price (“maximum unique discount”) or with a certain relative bid price value among the bids used within the unique bid electronic auction session. The bid price can also be set by a bidder account from within a range of bid prices. In additional embodiments, the bid price can be expressed as a set price or a discount from a marketplace acquisition price. The bid price of a bid can be set upon use of the bid by the bidder account or at any time after commitment and prior to the initiation of the unique bid electronic auction session while the unique bid electronic auction session is being set up. In specific embodiments, bid prices can be set secretly without notifying the other bidder accounts during the unique bid electronic auction session. In certain embodiments, a bidder account that commits to the unique bid electronic auction session can be debited for an entry price and ascribed with a start quantity of at least one bid that can be used upon the initiating of the unique bid electronic auctions session. Furthermore, additional bids can be ascribed for a purchased bid price to the bidder account that commits to the unique bid electronic auctions session beyond the start quantity of at least one bid. In certain embodiments, the number of additional bids that can be purchased can be capped, such as but not limited to with the maximum number of bids that can be ascribed to bidder accounts in the unique bid electronic auction session or at a certain quantity of additional bids per bidder account (such as a set integer number or a percentage of the maximum number of bids that can be ascribed to bidder accounts in the unique bid electronic auctions session. In particular embodiments, the set number of bidder accounts required for initiation of the unique bid electronic auction session can be reduced by the number of additional bids in the unique bid electronic auction session. The unique bid electronic auction session can be executed by generating an ordered list of each bid used based upon the bid price. The ordered list can be utilized to determine the winning bid as the bid with a bid price that satisfies the particular condition for determining the winning bid. In additional embodiments, a bidder account that participates in a unique bid electronic auction session but is not associated with a winning bid can elect to be credited with the bid item and debited by the marketplace acquisition price of the bid item less any expenditures incurred during the unique bid electronic auction session. Although electronic auctions sessions discussed above as unique bid electronic auction session have a winning bid as a bid with a unique bid price (such that only one bidder account is associated with the winning bid), electronic auction sessions can determine a winning bid based upon different conditions and/or have multiple bidder accounts associated with single or multiple winning bids.

In select embodiments, an auction server can pause an electronic auction session in performance of processes related to the execution of the electronic auction session. The auction server can pause the electronic auction session upon use of a bid by a bidder account and/or upon an achievement of an elapsed time (such as but not limited to after a certain amount of time has elapsed). During the pause, the auction server can perform processes that solve latency issues and/or processes related to executing the electronic auction session (such as but not limited to determining the earliest bid received).

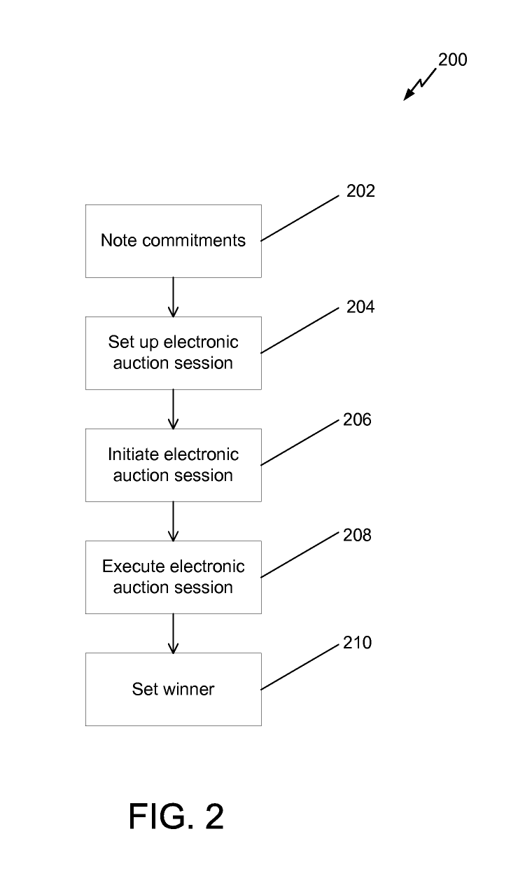

FIG. 2 is a flow chart of an electronic auction process that can be implemented in the electronic auction system of FIG. 1 in accordance with an exemplary embodiment. In certain embodiments, the process can be performed by the auction server 102. Although the process 200 in FIG. 2 is illustrated in a particular order, in certain embodiments the blocks herein may be performed in a different order, simultaneously, or omitted, and additional blocks can be added. A person of ordinary skill in the art will appreciate that the process 200 of the illustrated embodiment may be implemented in any auction server 102 that can be configured to communicate over a network and maintain an auction database.

At block 202, commitments from each of the bidder accounts of a set number of bidder accounts are received for an electronic auction session. The commitments are received as indications from a user interface of a bidder device associated with a bidder account by the auction server 102.

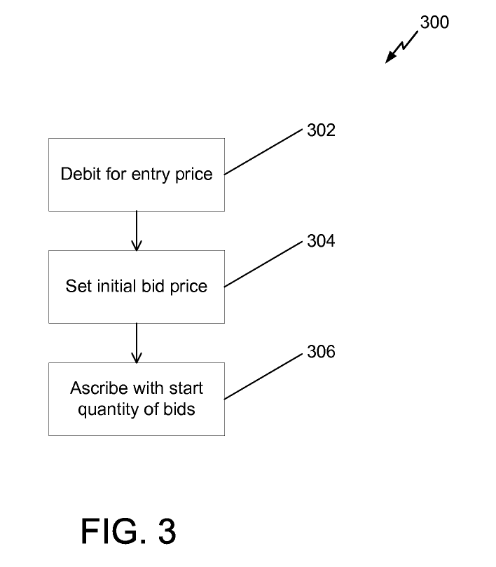

At block 204, the electronic auction session is set up in accordance with the rules of the electronic auction session. Further discussion of how the electronic auction session is set up is provided in FIG. 3.

At block 206, the electronic auction session is initiated among the set number of bidder accounts after each bidder account of the set number of bidder accounts has committed to the electronic auction session.

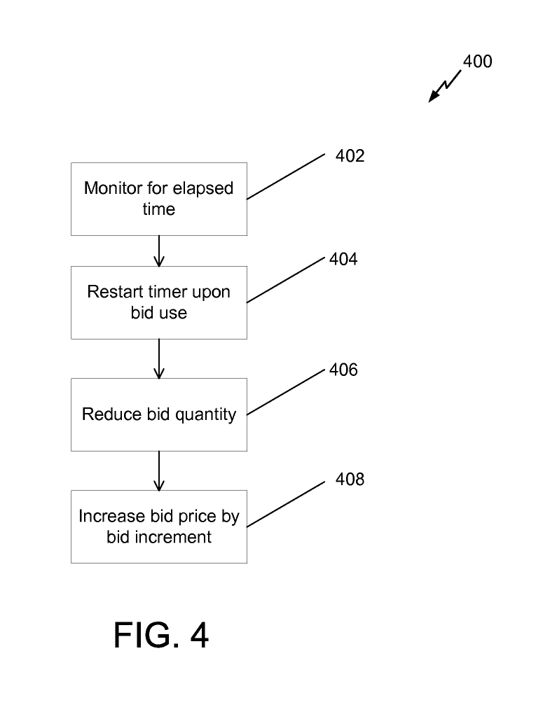

At block 208, the electronic auction session is executed. Further discussion of how the electronic auction session is executed is provided in FIG. 4.

At block 210, a winner is set from the electronic auction session. The winner is set upon the end of the electronic auction session. In certain embodiments, the winner of the electronic auction session is a first bidder account that committed to the electronic auction session. In further embodiments, the winner of the electronic auction session is the bidder account associated with the winning bid, where a bid can be the winning bid based upon any criteria such as (but not limited to) a time the bid was used or the particular bid price associated with the bid. For example, the winning bid can be the last used bid in the electronic auction session where the winner of the electronic auction session is the current bidder account that last used a bid (the winning bid) in the electronic auction session. Another example includes where the winning bid can be the bid with the highest unique bid price in an electronic auction session. In particular embodiments, the bidder account associated with the winning bid is debited by the bid price and credited with the bid item.

FIG. 3 is a flow chart of a process of setting up an electronic auction session of FIG. 2 in accordance with an exemplary embodiment. In certain embodiments, the process can be performed by the auction server 102. Although the process 300 in FIG. 3 is illustrated in a particular order, in certain embodiments the blocks herein may be performed in a different order, simultaneously, or omitted, and additional blocks can be added. A person of ordinary skill in the art will appreciate that the process 300 of the illustrated embodiment may be implemented in any auction server 102 that can be configured to set up an electronic auction session.

At block 302 each bidder account of the set number of bidder accounts is debited for an entry price.

At block 304 a bid price for the electronic auction session is set to an initial bid price.

At block 306 each bidder account of the set number of bidder accounts is ascribed with a start quantity of bids. Although the illustrated embodiment discusses ascribing each of the set number of bidder accounts in an electronic auction session with the same start quantity of bids, the start quantity of bids can be varied where different bidder accounts can be ascribed with different start quantity of bids in accordance with additional embodiments. In certain embodiments, a different start quantity of bids (such as but not limited to a greater start quantity of bids) can be used as an incentive for commitment of bidder accounts to an electronic auctions session.

In various embodiments, ascribing each bidder account with a start quantity of bids upon the initiating of the electronic auction session and allowing bidder accounts to purchase additional bids can be advantageous as an increased rate at which bids are used can be realized closer to the initiation of the electronic auction session.

FIG. 4 is a flow chart of a process of executing an electronic auction session of FIG. 2 in accordance with an exemplary embodiment. In certain embodiments, the process can be performed by the auction server 102. Although the process 400 in FIG. 4 is illustrated in a particular order, in certain embodiments the blocks herein may be performed in a different order, simultaneously, or omitted, and additional blocks can be added. A person of ordinary skill in the art will appreciate that the process 400 of the illustrated embodiment may be implemented in any auction server 102 that can be configured to execute an electronic auction session.

At block 402, a timer is monitored for an elapsed time from an initial time.

At block 404, the timer is restarted to the initial time upon use of a bid by a current bidder account that has most recently used a bid.

At block 406, the quantity of bids ascribed to the current bidder account is reduced upon the use of the bid by the current bidder account. In certain embodiments, the current bidder account cannot use additional bids once the quantity of bids ascribed to the current bidder account is exhausted. In particular embodiments, a bidder account is not limited to using up to a certain quantity of bids.

At block 408, the bid price is increased by the bid increment upon use of the bid by the current bidder account. In specific embodiments, the bid increment is a scaled value of the marketplace acquisition price. In certain embodiments, the bid increment is constant throughout an electronic bidding session for all participating bidder accounts. In additional embodiments, the bid increment can vary during an electronic auction session. Some examples include (but are not limited to) where bid increments can be different at different times in an electronic bidding session, where bid increments can be different for different players in an electronic bidding session, and where bid increments can be different for different players at different times in an electronic bidding session. In particular embodiments, the bid increment can be of any value above a minimum bid increment that is a minimum value from which the bid price is increased upon use of the bid by the current bidder account.

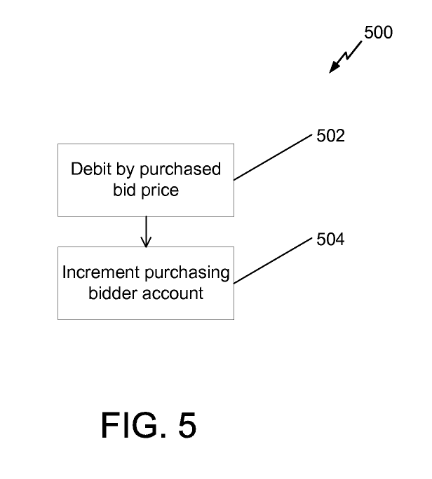

FIG. 5 is a flow chart of a process of purchasing additional bids in the electronic auction system of FIG. 1 in accordance with an exemplary embodiment. In certain embodiments, the process 500 can be performed by the auction server 102. Although the process 500 in FIG. 5 is illustrated in a particular order, in certain embodiments the blocks herein may be performed in a different order, simultaneously, or omitted, and additional blocks can be added. A person of ordinary skill in the art will appreciate that the process 500 of the illustrated embodiment may be implemented in any auction server 102 that can be configured to execute a process of purchasing additional bids.

At block 502, a purchasing bidder account is debited for a purchased bid price upon the purchasing bidder account purchasing an additional bid. The purchased bid price can be a scaled value of the marketplace acquisition price of the bid item.

At block 504, the purchasing bidder account can be incremented with an additional bid upon debiting the purchasing bidder account for the purchased bid price. In certain embodiments, an additional bid increment, as a bid increment associated with an additional bid, can be variable relative to other bid increments such as but not limited to standard bid increments associated with bids ascribed to a bidder account as the bidder account's start quantity of bids upon initiating of the electronic auction session. In particular embodiments, the additional bid increment can be of any value over a minimum bid increment.

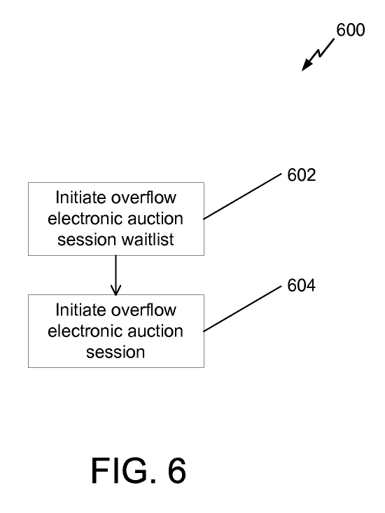

FIG. 6 is a flow chart of initiating an overflow electronic auction session in the electronic auction system of FIG. 1 in accordance with an exemplary embodiment. In certain embodiments, the process 600 can be performed by the auction server 102. Although the process 600 in FIG. 6 is illustrated in a particular order, in certain embodiments the blocks herein may be performed in a different order, simultaneously, or omitted, and additional blocks can be added. A. person of ordinary skill in the art will appreciate that the process 600 of the illustrated embodiment may be implemented in any auction server 102 that can be configured to execute a process of initiating an overflow electronic auction session.

At block 602, an overflow electronic auction session waitlist is initiated upon commitment of an overflow bidder account that commits to the electronic auction session after each bidder account of the set number of bidder accounts has committed to the electronic auction session. In certain embodiments, the overflow electronic auction session waitlist can be initiated before the electronic auction session is initiated. In additional embodiments, the overflow electronic auction session waitlist can be initiated after the electronic auction session is initiated.

At block 604, an overflow electronic auction session is initiated after commitment of the set number of overflow bidders. In certain embodiments, the set number of overflow bidders is the same as the set number of bidders for a non-overflow electronic auction session.

Although specific embodiments for executing an electronic auction session are discussed above, electronic auction sessions can be executed in accordance with various embodiments in different ways in accordance with additional embodiments.

### Further Exemplary Embodiments

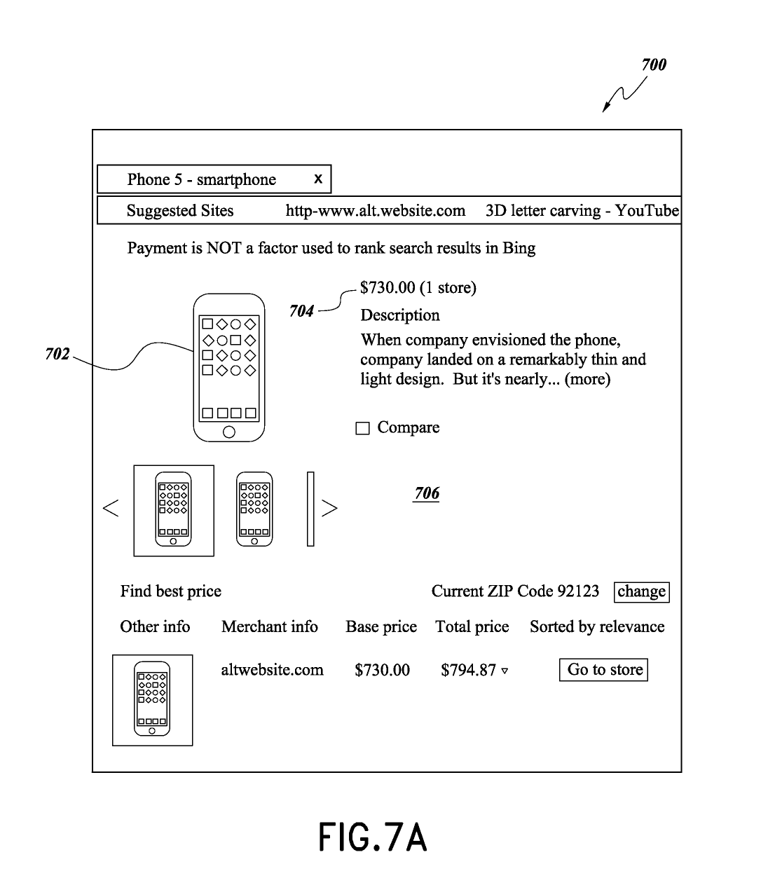

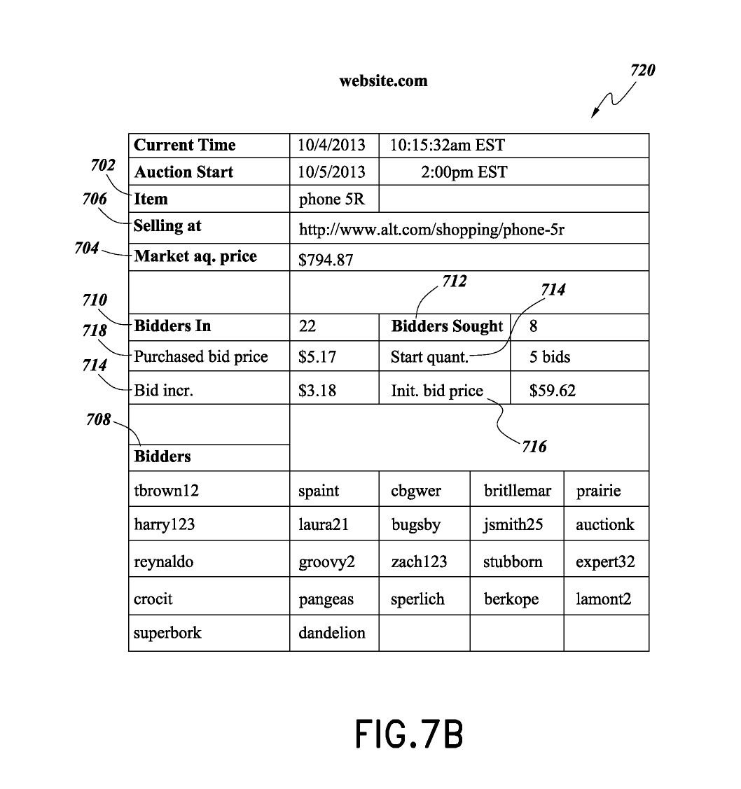

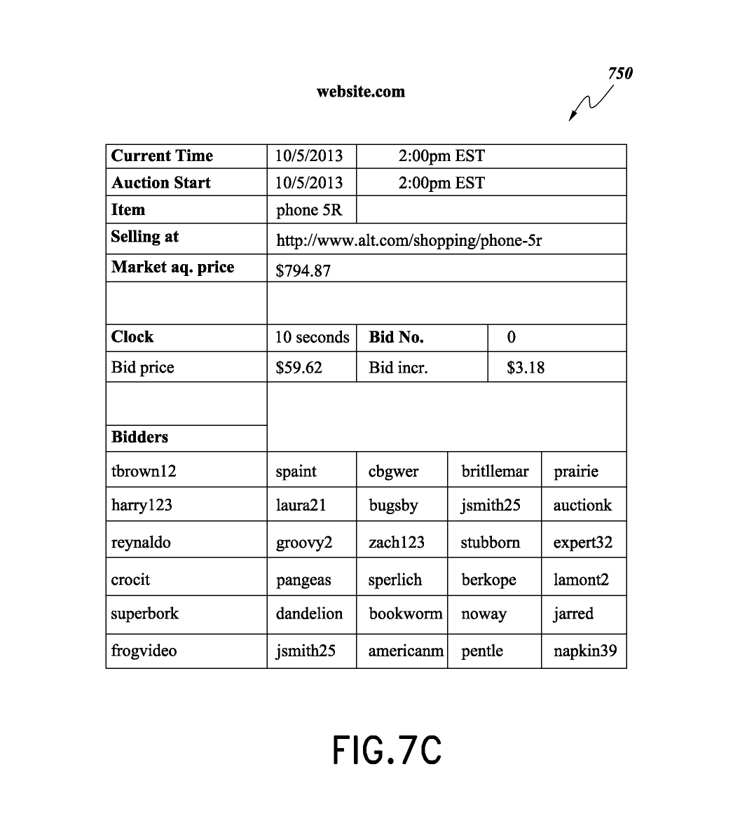

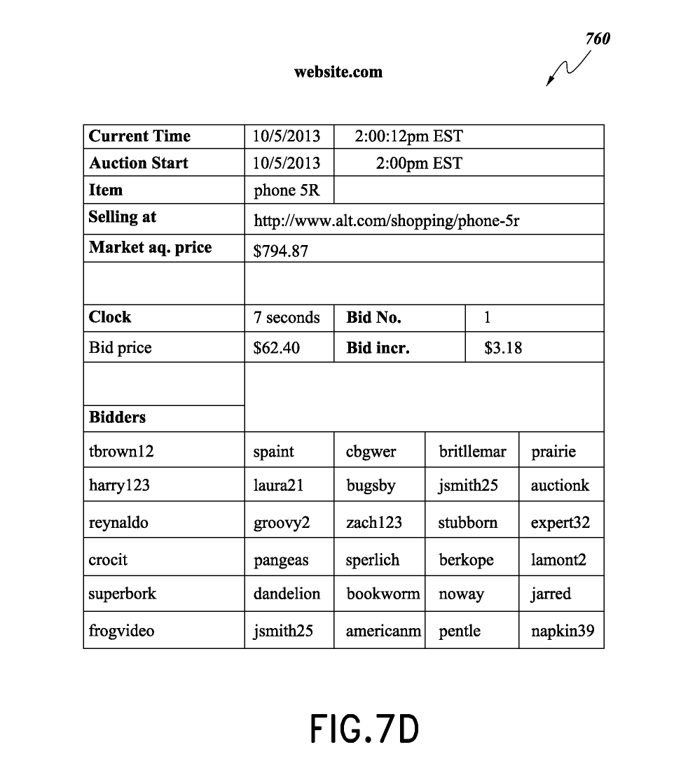

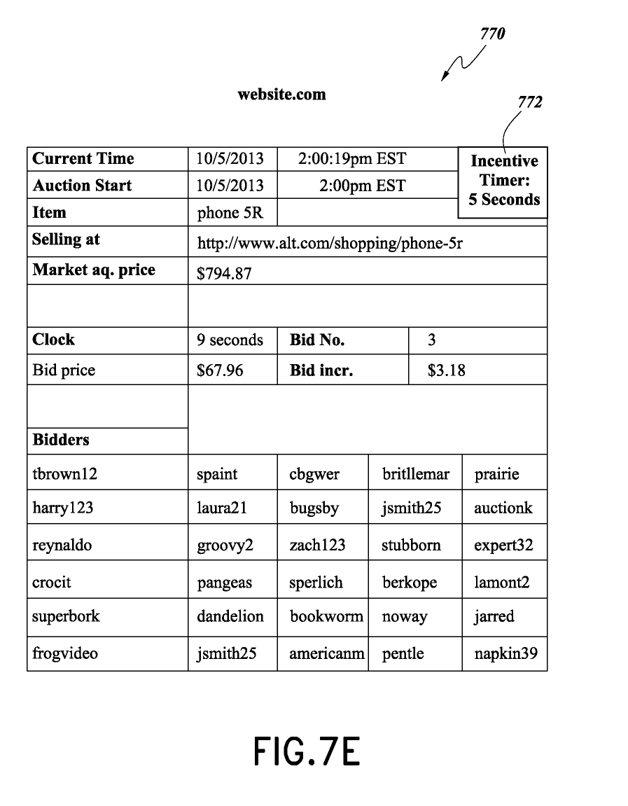

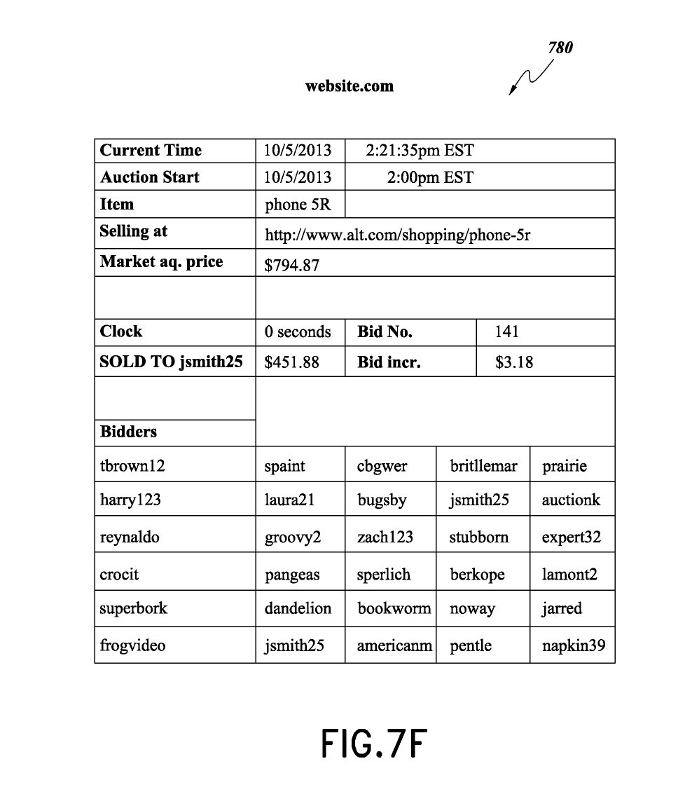

FIGS. 7A to 7F illustrate various aspects of an electronic auction session that can be implemented in the electronic auction system of FIG. 1 in accordance with an exemplary embodiment. FIG. 7A is a screenshot 700 of a bid item 702 with a listing of a marketplace acquisition price 704 for the bid item 702 implementable in the electronic auction system 100 of FIG. 1 in accordance with an exemplary embodiment. As illustrated in FIG. 7A, the bid item 702 is a smart phone sold on a third party web page 706.

FIG. 7B is a screenshot of a notice 720 for an electronic auction session that can be implemented in the electronic auction system of FIG. 1 in accordance with an exemplary embodiment. The notice 720 indicates that the current date is Oct. 4, 2013 and that the electronic auction session is to be held on Oct. 5, 2013 at 2:00 pm EST. The notice includes a listing of the bid item 702 marketplace acquisition price 704 and a link to the bid item 706. The notice includes information such as the names of bidder accounts 708 currently committed to the electronic auction session. The notice also includes information such as the number of bidder accounts 710, the number of bidder accounts that are required to commit to the electronic auction session to make the set number of bidders for initiating the electronic auctions session 712, the bid increment 714, initial bid price 716 and purchased bid price 718. In the illustrated embodiment, the price for the purchased bid 718 during the auction (purchased bid price) is 0.65% of the bid item's marketplace acquisition price, or $5.17. Use of a bid raises the current bid price of the auction by a bid increment 714 equal to 0.4% of the bid item's marketplace acquisition price 704, or $3.18. The initial bid price 716 can be 7.5% of the item's marketplace acquisition price 704, or $59.62. The set number of bidders in this electronic auction session is 30 bidder accounts. If 30 bidder accounts have not committed to the electronic auction session or if the bid price of the winning bid is below the reserve price of the bid item, the electronic auction session is then cancelled or rescheduled. In the illustrated embodiment, the entry price is the purchased bid price 718 multiplied by the start quantity of bids 714. If the auction is cancelled or rescheduled, the entry price can be refunded to the bidder accounts of the cancelled or rescheduled electronic auction session. During the electronic auction session, a bidder account may use bids from the start quantity of bids. If the start quantity of bids runs out, the bidder account can purchase additional bids at the purchased bid price 718. In particular embodiments, unused bids at the end of the electronic auction session are no longer usable.

FIG. 7C is a screenshot of a user interface 750 at electronic auction session initiation of the electronic auction session of FIG. 7B. The electronic auction session can be initiated upon commitment of each bidder account of the set number of bidder accounts, 30 in the illustrated embodiment. The electronic auction session begins with the first bid, where each bidder account can use a bid before achievement of a ten second elapsed time period. If no bids are used in the next ten seconds, the first bidder account to commit to the electronic auction session (Tbrown12) can be set as the winner of the electronic auction session. The first bidder account to commit to the electronic auction session (Tbrown12) can then be debited by the bid price ($59.65) and credited with the bid item.

FIG. 7D is a screenshot of a user interface 760 for the electronic auction session of FIG. 7B 12 seconds after initiation of the electronic auction session. The first bid was used three seconds ago. If ten seconds is achieved as the elapsed time, the auction ends with the bid item sold to the first bidder account (current bidder account) by being debited by the bid price of $62.40 and credited with the bid item.

FIG. 7E is a screenshot 770 of a user interface for the electronic auction session of FIG. 7B 19 seconds after initiation of the electronic auction session. The third bid was one second ago. If ten seconds is achieved as the elapsed time, the auction ends with the bid item sold to the current bidder account (bidder account of the third bid) by debiting the current bidder account by the bid price of $67.96 and crediting the current bidder account with the bid item.

In certain embodiments, an incentive timer 772 may be implemented to refund or credit a bidder account that last used a bid by a bid price upon an achievement of an elapsed time according to the incentive timer 772 without use of a bid by any bidder account. In the illustrated embodiment, the incentive timer is configured to determine when the achievement of an elapsed time of five seconds has occurred. Thereby, bidder accounts may be incentivized to use a bid prior to achievement of the elapsed time according to the incentive timer 772 in order to accelerate the use of bids and/or to prevent a competitor bidder account from receiving an advantage (such as a refund or credit to the bidder account that last used a bid). The incentive timer may be utilized in a variety of circumstances during an electronic auction session, such as periodically or as arbitrarily called upon by the operator of the electronic auction session.

FIG. 7F is a screenshot 780 of a user interface for the electronic auction session of FIG. 7B 21 minutes and 35 seconds after initiation of the electronic auction session. Ten elapsed seconds was achieved with Jsmith25 as the current bidder account at the 141^{st} bid. The bid item was then sold to Jsmith25 by debiting Jsmith25 by the bid price of $451.88 and crediting Jsmith25 with the bid item. Each of the unused bids (at least 9) is a sunk cost of the bidder account associated with the unused bids. Therefore, if all bidder accounts only used their start quantity of bids during an electronic auction session, then the maximum bid price is $59.62+30*5*$3.18=$536.54, 67.5% of the marketplace acquisition price of the bid item. The price discount to the winning bidder account is (100−67.5−3.25)%=29.25%. A bidder account that is not the winner of the electronic auction session that uses only the start quantity of bids during the electronic auction session will be debited by 3.25% of the bid item's marketplace acquisition price.

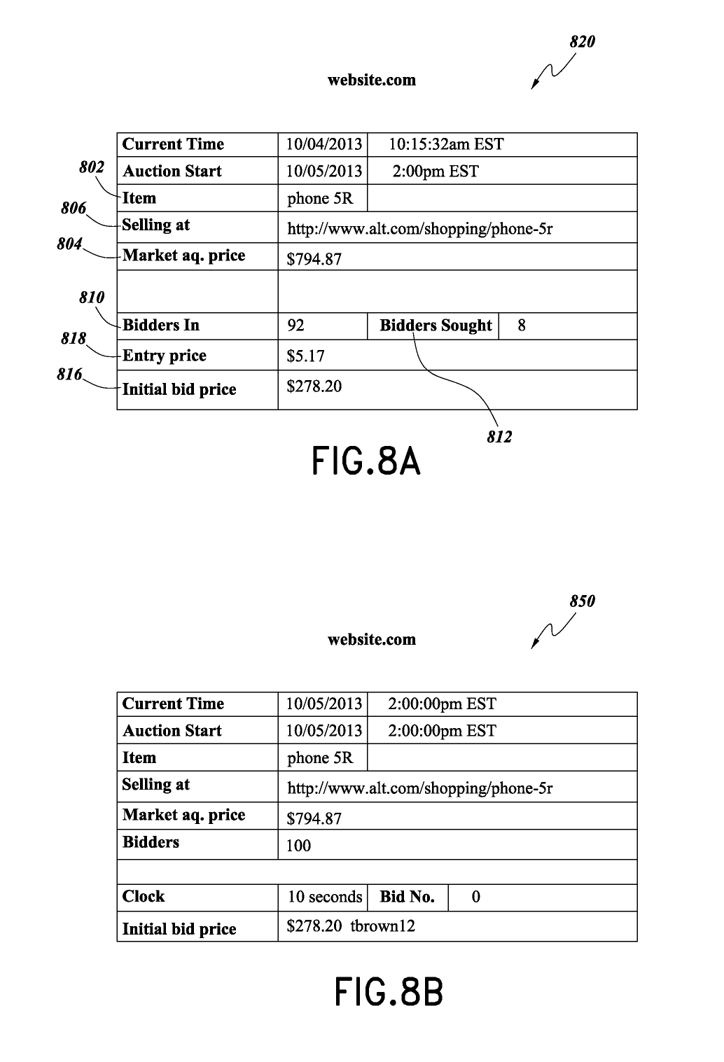

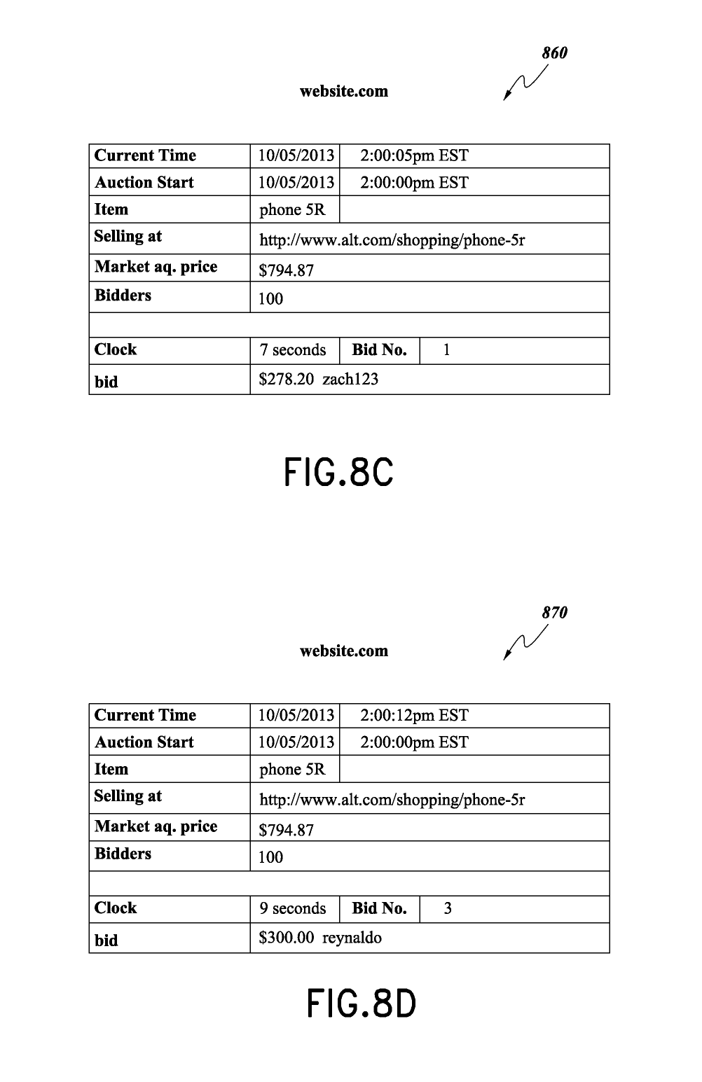

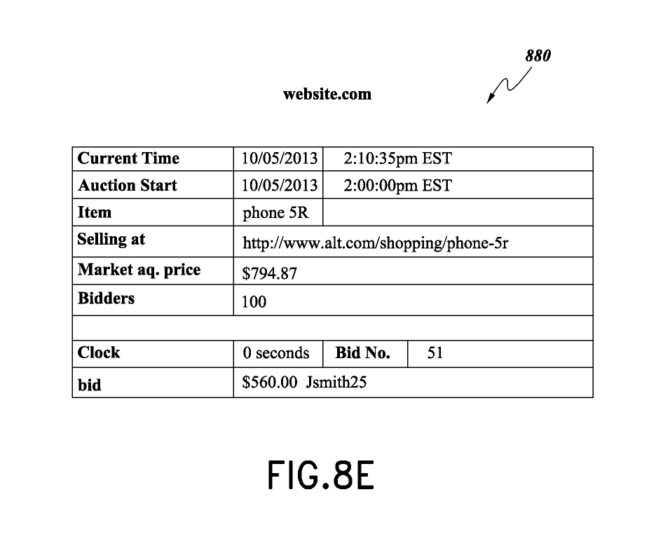

FIGS. 8A to 8E illustrate various aspects of another version of an electronic auction session that can be implemented in the electronic auction system of FIG. 1 but that differs from the electronic auction session of FIGS. 7A to 7F by the number of bidder accounts committed to the electronic auction session and type of bid increment in accordance with an exemplary embodiment.

FIG. 8A is a screenshot of a notice 820 for an electronic auction session that can be implemented in the electronic auction system of FIG. 1 in accordance with an exemplary embodiment. The notice 820 indicates that the current date is Oct. 4, 2013 and that the electronic auction session is to be held on Oct. 5, 2013 at 2:00 pm EST. The notice 820 includes a listing of the bid item 802 marketplace acquisition price 804 and a link to the bid item 806. The notice also includes information such as the number of bidder accounts 810, the number of bidder accounts that are required to commit to the electronic auction session to make the set number of bidders for initiating the electronic auctions session 812, initial bid price 816 and entry price 818. In the illustrated embodiment, the entry price 818 during the auction is 0.65% of the bid item's marketplace acquisition price, or $5.17. The initial bid price 816 can be 35% of the item's marketplace acquisition price 804, or $278.20. The set number of bidders in this electronic auction session is 100 bidder accounts. If 100 bidder accounts have not committed to the electronic auction session or if the bid price of the winning bid is below the reserve price of the owner of the bid item, the electronic auction session is then cancelled or rescheduled. If the auction is cancelled or rescheduled, the entry price can be refunded to the bidder accounts of the cancelled or rescheduled electronic auction session.

FIG. 8B is a screenshot of a user interface 850 at electronic auction session initiation of the electronic auction session of FIG. 8A. The electronic auction session can be initiated upon commitment of each bidder account of the set number of bidder accounts, 100 in the illustrated embodiment. The electronic auction session begins with the first bid, where each bidder account can place a bid before achievement of a ten second elapsed time period. If no bids are used in the next ten seconds, the first bidder account to commit to the electronic auction session (Tbrown12) can be set as the winner of the electronic auction session. The first bidder account to commit to the electronic auction session (Tbrown12) can then be debited by the bid price ($278.20) and credited with the bid item.

FIG. 8C is a screenshot of a user interface 860 for the electronic auction session of FIG. 8A 5 seconds after initiation of the electronic auction session. The first bid of the electronic auction session was used three seconds ago by Zach123. If ten seconds is achieved as the elapsed time, the auction ends with the bid item sold to the current bidder account that last used a bid (Zach123) by being debited by the bid price of $278.70 and credited with the bid item.

FIG. 8D is a screenshot 870 of a user interface for the electronic auction session of FIG. 8A 12 seconds after initiation of the electronic auction session. The third bid was one second ago. If ten seconds is achieved as the elapsed time, the auction ends with the bid item sold to the current bidder account (Reynaldo) by debiting the current bidder account by the bid price of $300 and crediting the current bidder account with the bid item.

As discussed above, in certain embodiments, a bid increment can be of any value over a minimum bid increment. In the embodiments illustrated in FIGS. 8A to 8E, the minimum bid increment, is $0.50 and therefore the bid price is increased by a minimum of $0.50 upon each use of a bid. FIG. 8D reflects an embodiment where the bid price was increased with the second or third bid by a value greater than the minimum bid increment of $0.50.

FIG. 8E is a screenshot 880 of a user interface for the electronic auction session of FIG. 8A 10 minutes and 35 seconds after initiation of the electronic auction session. Ten elapsed seconds was achieved with Jsmith25 as the current bidder account at the 51^{st} bid. The bid item was then sold to Jsmith25 by debiting Jsmith25 by the bid price of $560 and crediting Jsmith25 with the bid item. A bidder account that is not the winner of the electronic auction session will be debited only by the entry price of $5.17.

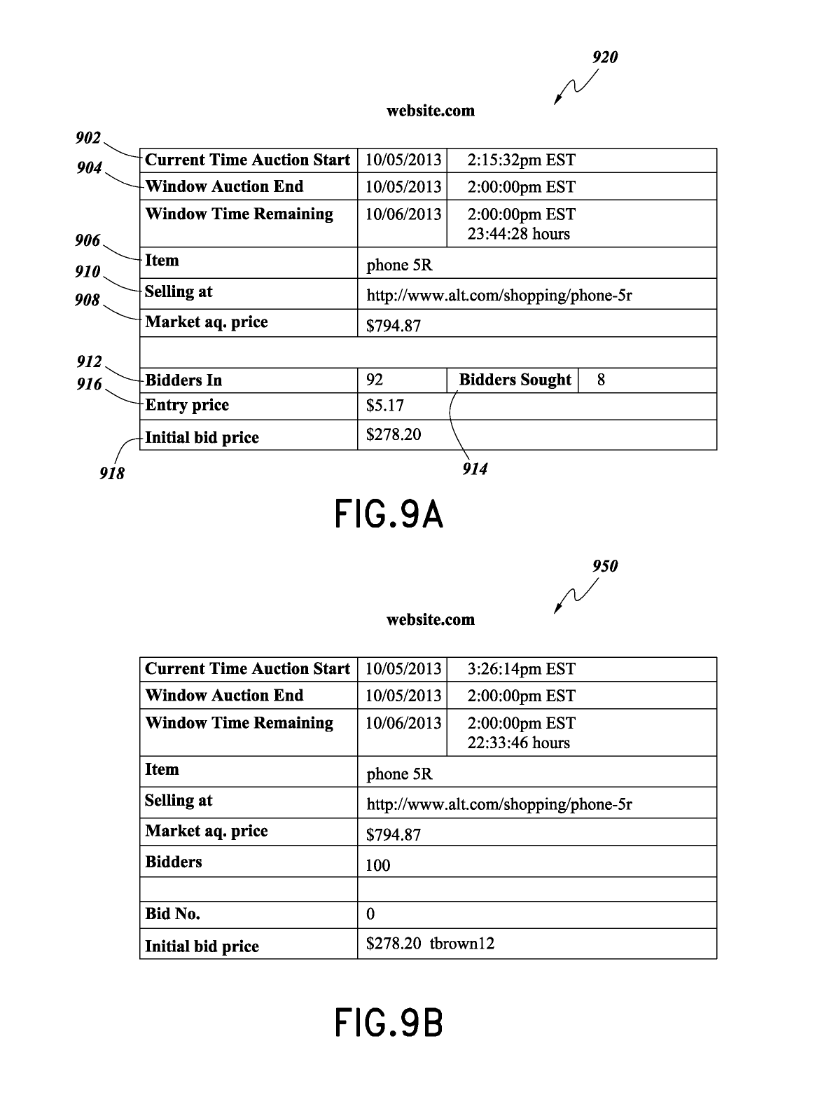

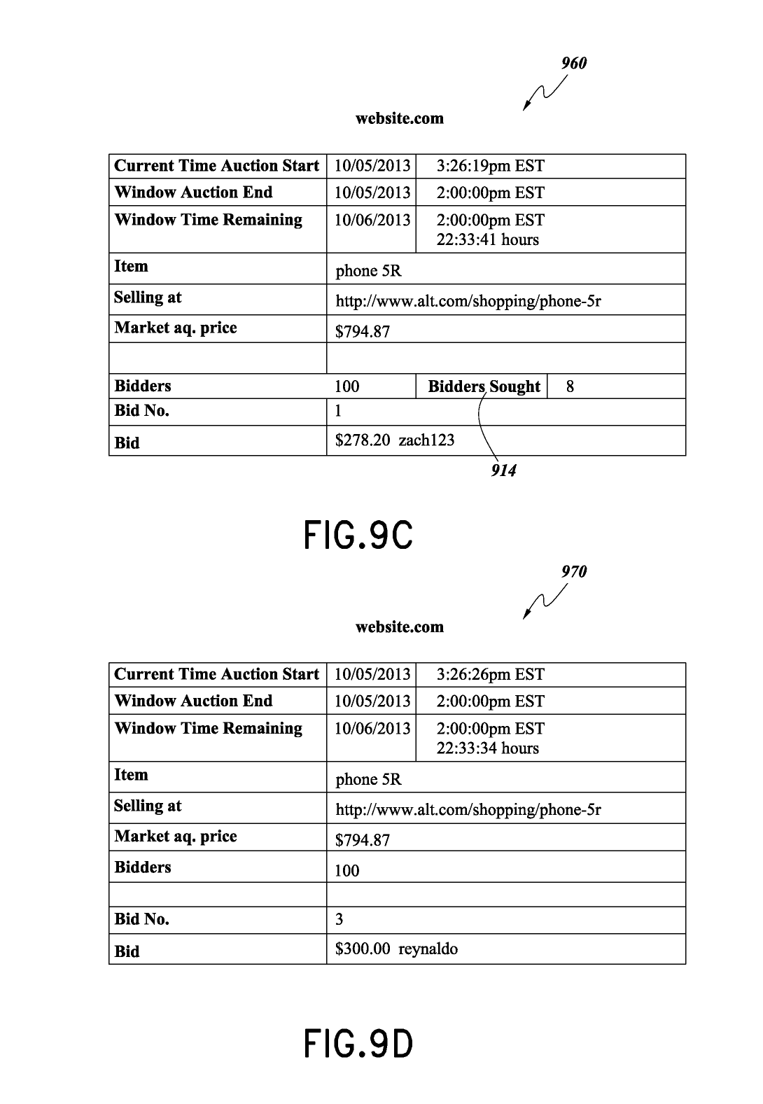

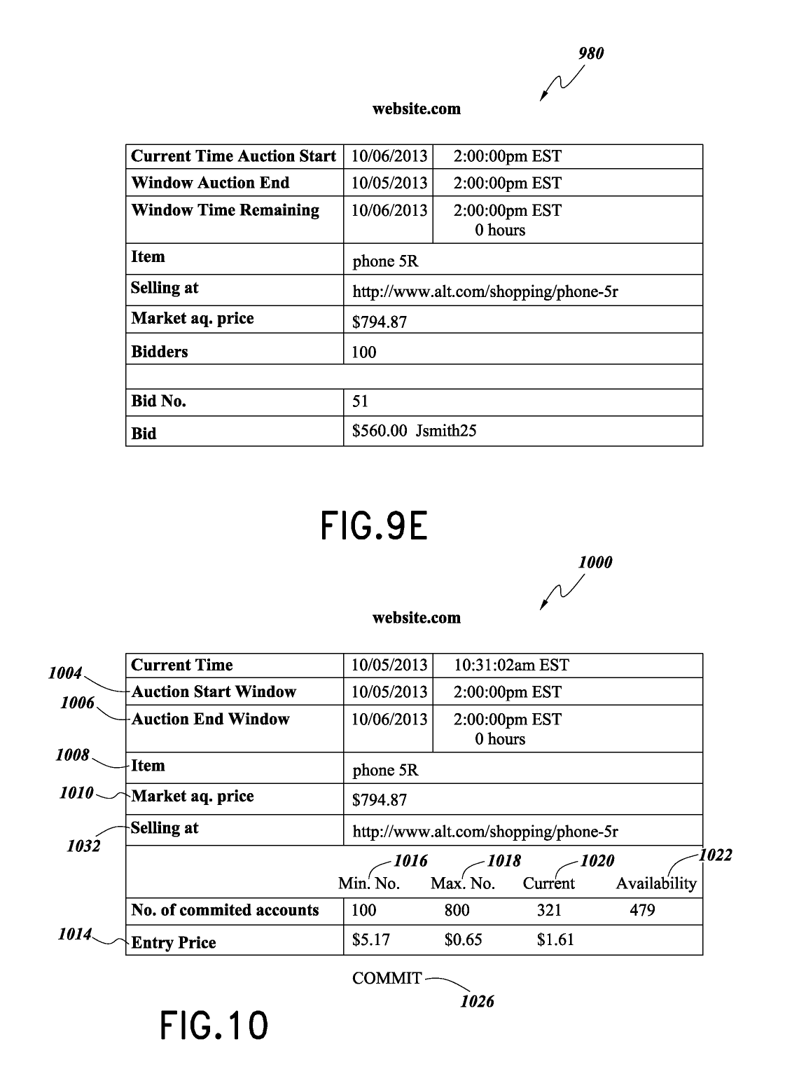

FIGS. 9A to 9E illustrate various aspects of another version of an electronic auction session that can be implemented in the electronic auction system of FIG. 1 but that differs from the electronic auction session of FIGS. 7A to 8E with a different achievement of an elapsed time that ends an electronic auction session in accordance with an exemplary embodiment.

FIG. 9A is a screenshot of a notice 920 for an electronic auction session that can be implemented in the electronic auction system of FIG. 1 in accordance with an exemplary embodiment. This electronic auction session includes an auction start window 902 from which the electronic auction session can start once the set number of bidder accounts has committed to the electronic auction session. The electronic auction session also includes an auction end window upon 904 which the electronic auction session ends. Thereby, the electronic auction session ends upon the achievement of an elapsed time that meets the auction end window 904. The notice 920 indicates that an auction start window occurred 15 minutes and 32 seconds ago, and that the auction end window will occur in 23 hours, 44 minutes and 28 seconds. The notice includes a listing of the bid item 906 marketplace acquisition price 908 and a link to the bid item 910. The notice also includes information such as the number of bidder accounts 912, the number of bidder accounts that are required to commit to the electronic auction session to make the set number of bidders for initiating the electronic auctions session 914, initial bid price 918 and entry price 916. In the illustrated embodiment, the entry price 916 during the auction is 0.65% of the bid item's marketplace acquisition price, or $5.17. The initial bid price 918 can be 35% of the item's marketplace acquisition price 908, or $278.20. The set number of bidders in this electronic auction session is 100 bidder accounts. If 100 bidder accounts have not committed to the electronic auction session or if the bid price of the winning bid is below the reserve price of the owner of the bid item, the electronic auction session is then cancelled or rescheduled. If the auction is cancelled or rescheduled, the entry price can be refunded to the bidder accounts of the cancelled or rescheduled electronic auction session.

FIG. 9B is a screenshot of a user interface 950 at the initiation of the electronic auction session of FIG. 9A. The electronic auction session can be initiated upon commitment of each bidder account of the set number of bidder account, 100 in the illustrated embodiment, after the auction start window. Use of the first bid will increase the bid price by at least the minimum bid increment, $0.50 in this illustrated embodiment. If no bids are placed before the auction end (at the auction end window), the first bidder account to commit to the electronic auction session (Tbrown12) can be set as the winner of the electronic auction session. The first bidder account to commit to the electronic auction session (Tbrown12) can then be debited by the bid price ($278.20) and credited with the bid item.

FIG. 9C is a screenshot of a user interface 960 for the electronic auction session of FIG. 9A 1 hour, 26 minutes and 19 seconds after the auction start window. If no further bids are placed before the auction end window, the auction ends with the bid item sold to the current bidder account (Zach123) by being debited by the bid price of $278.70 and credited with the bid item. Due to the electronic auction session ending upon the achievement of an elapsed time that meets the auction end window, the bidder accounts participating in the electronic auction session need not be active by using bids in order to prolong the electronic auction session.

FIG. 9D is a screenshot 970 of a user interface for the electronic auction session of FIG. 9A 1 hour, 26 minutes and 26 seconds after the auction start window. If no further bids are placed before the auction end window, the auction ends with the bid item sold to the current bidder account (reynaldo) by debiting the current bidder account by the bid price of $300 and crediting the current bidder account with the bid item.

FIG. 9E is a screenshot 980 of a user interface for the electronic auction session of FIG. 9A at the end of the auction. The bid item was then sold to Jsmith25 by debiting Jsmith25 by the bid price of $560 and crediting Jsmith25 with the bid item. A bidder account that is not the winner of the electronic auction session will be debited only by the entry price of $5.17.

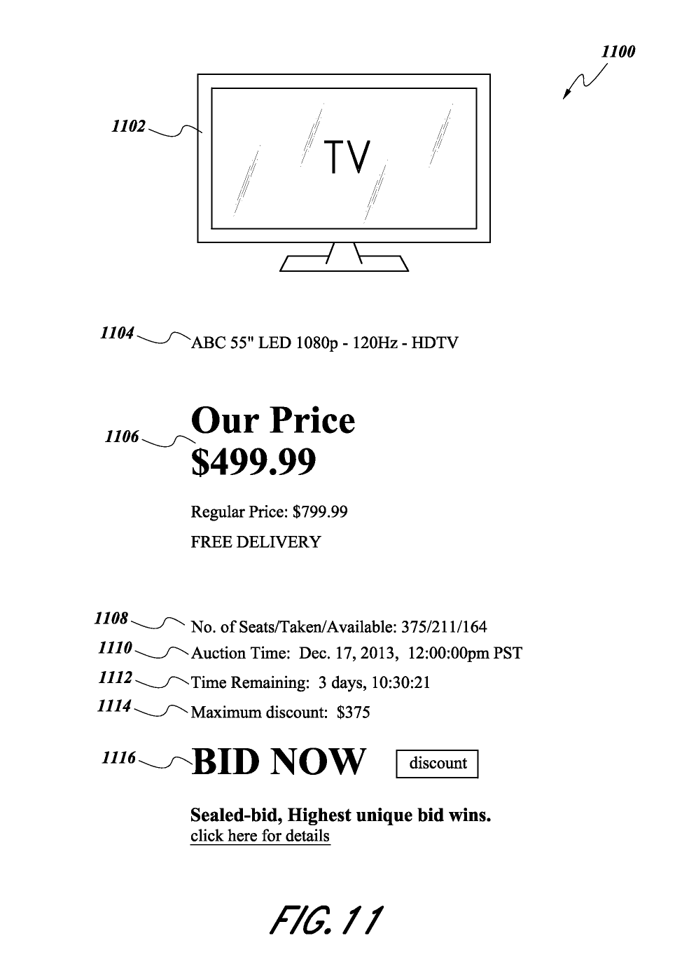

FIG. 10 is a screenshot of an invitation 1000 to join a customized electronic auction session that can be implemented in the electronic auction system of FIG. 1 in accordance with an exemplary embodiment. This customized electronic auction session includes an auction start window 1004. In particular embodiments, the customized electronic auction session can be cancelled if the minimum set number of customizing bidder accounts 1016 has not committed to the customized electronic auction session upon the occurrence of the auction start window 1004. In certain embodiments, the electronic auction session can start once the minimum set number of customizing bidder accounts 1016 has committed to the customized electronic auction session after the auction start window 1004. The electronic auction session also includes an auction end window 1006 upon which the customized electronic auction session ends. In the illustrated embodiment, the auction start window has not yet occurred. The invitation includes a listing of the bid item 1008, marketplace acquisition price 1010, and a link to the bid item 1032. The invitation also includes information such as the minimum set number of committed customizing bidder accounts 1016 for initiation of the customized electronic auction session, the maximum set number 1018 of customizing bidder accounts that can commit to the customized electronic auction session, current number 1020 of committed customizing bidder accounts and availability 1022 for additional customizing bidder accounts to commit to the customized electronic auction session. The invitation also includes the entry price 1014 associated with each of the minimum set number 1016 of committed customizing bidder accounts for initiation of the customized electronic auction session, the maximum set number 1018 of customizing bidder accounts that can commit to the customized electronic auction session and the current number 1020 of committed customizing bidder accounts.

In the illustrated embodiment, the invitation is indicated by the COMMIT button 1026 by which a customizing bidder account can select to commit to the customized electronic auction session. The parameters of the customized electronic auction session can be customized by the customizing bidder account committing to the customized electronic auction session. In the illustrated embodiment, the entry price of the customized electronic auction session decreases with more commitments from customizing bidder accounts and thereby the customizing bidder account can change the entry price 1014 by committing to the customized electronic auction session.

FIG. 11 is a screenshot of a user interface of a unique bid electronic auction session that can be implemented in the electronic auction system of FIG. 1 in accordance with an exemplary embodiment. The user interface 1100 includes information concerning the bid item, such as a representative illustration 1102 of the bid item and technical specifications 1104 of the bid item. The user interface 1100 also includes a marketplace acquisition price 1106 of the bid item. The total number of bids available 1108 in the electronic auction session is also illustrated and termed as a “seat.” The set number of bidder accounts required for initiation of the unique bid electronic auction session (which can be zero) is not presented in the user interface. In certain embodiments, the set number of bidder accounts required for initiation of the unique bid electronic auction session can be inversely related to the number of additional bids in the unique bid electronic auction session. Furthermore, an auction time 1110 (as an achievement of the elapsed time indicated by a timer 1112) by which the set numbers of bidder accounts are required to commit to the unique bid electronic auction session prior to initiation of the unique bid electronic auction session is presented. In certain embodiments, the initiation of the unique bid electronic session is at auction time 1100. A range of bid prices within which a bid price can be set by a bidder account is also presented with indication of a maximum discount 1114 that correlates with the minimum bid price. In certain embodiments, a range of bid prices within which a bid price can be set by a bidder account is also presented with indication of a maximum bid price. In certain embodiments, a range of a pre-determined number of consecutive bid prices is disallowed to be set by a bidder account. In the illustrated embodiment, the winning bid can be the bid with a bid price that is the lowest unique bid price above the minimum bid price. In certain embodiments, the winning bid can be the bid with a bid price that is the highest unique bid price at or below the maximum bid price. In certain embodiments, the winning bid can be a first bid used with a bid price that is the highest duplicate bid price at or below the maximum bid price. Bids can be used with bid prices represented as a discounted value from the marketplace acquisition price within the user interface. In certain embodiments, the electronic auction session ends in a specified amount of time after the point when the number of available seats 1108 becomes zero. A winner of the electronic auction session can be a bidder account associated with the winning bid, where the winner of the electronic auction session is debited by the winner of the electronic auction session's highest bid price and credited with the bid item. Also, a link 1116 is presented by which a bidder account can commit to the unique bid electronic auction session.

Although specific rules for executing an electronic auction session are discussed above, other rules can be implemented in the execution of an electronic auction session in accordance with different embodiments. In certain embodiments, an initial bid price, purchased bid price and bid increment can be about 45%, 0.4% and 0.1% of a marketplace acquisition price of a bid item respectively. An entry price can be about 2% of the marketplace acquisition price of the bid item. Also, revenues made by an operator of an electronic auction session can be limited to a certain percentage of the marketplace acquisition price of the bid item, such as but not limited to 5%, 10%, 20%, 30%, 40%, 50%, or 60%.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the embodiments.

The various illustrative blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm and functions described in connection with the embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the processor such that the processor can read information from, and write information to, the storage medium. In the alternative, the storage medium may be integral to the processor. Disk and disc, as used herein, includes compact disc (CD), laser disc, optical disc, digital versatile disc (DVD), floppy disk and blu ray disc where disks usually reproduce data magnetically, while discs reproduce data optically with lasers. Combinations of the above should also be included within the scope of computer readable media. The processor and the storage medium may reside in an ASIC. The ASIC may reside in a user terminal. In the alternative, the processor and the storage medium may reside as discrete components in a user terminal.

For purposes of summarizing the disclosure, certain aspects, advantages and novel features of certain embodiments have been described herein. It is to be understood that not necessarily all such advantages may be achieved in accordance with any particular embodiment. Thus, the embodiments may be embodied or carried out in a manner that achieves or optimizes one advantage or group of advantages as taught herein without necessarily achieving other advantages as may be taught or suggested herein.

Various modifications of the above described embodiments will be readily apparent, and the generic principles defined herein may be applied to other embodiments without departing from the spirit or scope of the application. Thus, the present application is not intended to be limited to the embodiments shown herein but is to be accorded the widest scope consistent with the principles and novel features disclosed herein.

What is claimed is:

1. A method for electronic auctions using an auction server, comprising:
initiating an electronic auction session among a predetermined set number of bidder accounts after each bidder account of the set number of bidder accounts has committed to the electronic auction session;
debiting each bidder account for an entry price upon the initiating of the electronic auction session;
setting a bid price to an initial bid price upon the initiating of the electronic auction session;
monitoring a timer for an elapsed time; and
ending the electronic auction session upon an achievement of the elapsed time.

2. The method of claim 1, wherein the entry price multiplied by the set number of bidder accounts plus the initial bid price is greater than a marketplace acquisition price of a bid item of the electronic auction session.

3. The method of claim 1, comprising setting a winner of the electronic auction session once the electronic auction session ends without any bids used, where the winner of the electronic auction session is a first bidder account that committed to the electronic auction session.

4. The method of claim 1, comprising ascribing each bidder account with a start quantity of bids upon the initiating of the electronic auction session.

5. The method of claim 4, wherein the entry price multiplied by the set number of bidder accounts plus the initial bid price plus a bid increment multiplied by the total number of bids ascribed is greater than a marketplace acquisition price of a bid item of the electronic auction session.

6. The method of claim 4, wherein at least two bidder accounts are ascribed with a different start quantity of bids.

7. The method of claim 4, wherein the start quantity of bids is zero.

8. The method of claim 4, wherein the start quantity of bids is greater than zero.

9. The method of claim 4, wherein the monitoring the timer for the elapsed time comprises monitoring the timer for an elapsed time without use of a bid from an initial time.

10. The method of claim 9, comprising:
restarting the timer to the initial time upon use of a bid by a current bidder account;
reducing the quantity of bids ascribed to the current bidder account upon the use of a bid by the current bidder account, where the current bidder account cannot use additional bids once the quantity of bids ascribed to the current bidder account is exhausted;
setting a winner of the electronic auction session once the electronic auction session ends, where the winner of the electronic auction session is the current bidder account.

11. The method of claim 10, comprising crediting a bidder account that last used a bid by the bid price upon an achievement of an elapsed time as determined by an incentive timer without use of a bid by any bidder account.

12. The method of claim 10, comprising increasing the bid price by a bid increment upon the use of the bid by the current bidder account.

13. The method of claim 12, wherein the bid increment is a standard bid increment that is a scaled value of the marketplace acquisition price, where the standard bid increment is associated the bids of the current bidder account's start quantity of bids.

14. The method of claim 12, wherein the bid increment is above a minimum bid increment, where the minimum bid increment is a scaled value of the marketplace acquisition price.

15. The method of claim 12, wherein the bid increment is greater than 0.2% of the marketplace acquisition price.

16. The method of claim 11, wherein the marketplace acquisition price is an actual fair market price of the bid item.

17. The method of claim 11, wherein the marketplace acquisition price is less than an actual fair market price of the bid item.

18. The method of claim 11, wherein the winner of the electronic auction session is debited by the bid price and credited with the bid item.

19. The method of claim 1, comprising:
initiating an overflow electronic auction session waitlist upon commitment of an overflow bidder account that commits to the electronic auction session after each bidder account of the set number of bidder accounts has committed to the electronic auction session; and
initiating an overflow electronic auction session after commitment of a set number of overflow bidders.

20. The method of claim 19, wherein the set number of overflow bidders is the same as the set number of bidders.

21. The method of claim 10, comprising:
debiting a purchasing bidder account for a purchased bid price upon the purchasing bidder account purchasing an additional bid, where the purchased bid price is a scaled value of the marketplace acquisition price; and
incrementing the purchasing bidder account with an additional bid upon the debiting the purchasing bidder account for the purchased bid.

22. The method of claim 21, wherein the additional bid increases the bid price by an additional bid increment upon use of the additional bid by the purchasing bidder account.

23. The method of claim 22, wherein the additional bid increment differs from a standard bid increment that is a scaled value of the marketplace acquisition price, where the standard bid increment is associated with the bids of the purchasing bidder account's start quantity of bids.

24. The method of claim 1, wherein the entry price multiplied by the set number of bidder accounts plus the initial bid price is equal to a marketplace acquisition price of a bid item of the electronic auction session.

25. The method of claim 4, wherein the entry price multiplied by the set number of bidder accounts plus the initial bid price plus a bid increment multiplied by the total number of bids ascribed is equal to a marketplace acquisition price of a bid item of the electronic auction session.

26. The method of claim 12, wherein the bid increment is at a minimum bid increment, where the minimum bid increment is a scaled value of the marketplace acquisition price.

27. The method of claim 1, wherein the entry price is inversely related to the set number of bidder accounts committed to the electronic auction session.

28. A system for electronic auctions, comprising:
an auction database configured to store at least one bidder account; and
an auction server configured to maintain the auction database, where the auction server is further configured to initiate an electronic auction session among a predetermined set number of bidder accounts after each bidder account of the set number of bidder accounts has committed to the electronic auction session, where upon initiation of the electronic auction session, a bid price is set to an initial bid price and each bidder account is debited for an entry price upon initiating of the electronic auction session and ascribed with a start quantity of bids.

29. A method for electronic auctions using an auction server, comprising:
initiating an electronic auction session among a predetermined set number of bidder accounts after each bidder account of the set number of bidder accounts has committed to the electronic auction session;
debiting each bidder account for an entry price upon the initiating of the electronic auction session;
ascribing each bidder account with a start quantity of at least one bid upon the commitment to the electronic auction session;
recording a bid price for each bid used;
monitoring a timer for an elapsed time; and
initiating the electronic auction session upon an achievement of the elapsed time.

30. The method of claim 29, wherein the bid price for each bid used is not disclosed until an end of the electronic auction session.

31. The method of claim 29, comprising generating an ordered list of each bid used based upon the bid price for each bid used, wherein a winning bid is determined based upon a location within the ordered list.

32. The method of claim 29, comprising generating an ordered list of each bid used based upon a time of bid use for each bid used, wherein a winning bid is determined based upon a location within the ordered list.

33. The method of claim 29, wherein a winning bid has a highest bid price among each bid used prior to the end of the electronic auction session.

34. The method of claim 29, wherein a winning bid has a bid price that is the lowest unique bid price above a minimum bid price.

35. The method of claim 29, wherein a winning bid has a bid price that is the highest unique bid price below a maximum bid price.

36. The method of claim 29, wherein a winning bid is a first bid used with a bid price that is the highest duplicate bid price at or below a maximum bid price.

37. The method of claim 29, wherein a range of a pre-determined number of consecutive bid prices is disallowed to be set by a bidder account.

38. The method of claim 29, wherein the auction ends in an amount of time after all available bids are used.

39. The method of claim 29, wherein an amount of real world currency debited from a bidder account in the electronic auction session is credited to the bidder account for use after the electronic auction session.

40. The method of claim 33, comprising:
setting a winner of the electronic auction session once the electronic auction session ends, where the winner of the electronic auction session is a bidder account associated with the winning bid, and where the winner of the electronic auction session is debited by the winning bid price and credited with the bid item.

41. The method of claim 29, wherein the predetermined set number of bidder accounts is zero.

42. A method for electronic auctions, comprising:
sending a commitment message for a first bidder account associated with a bidder device from the bidder device to an auction server hosting an electronic auction session, where the commitment message configures the auction server to add the first bidder account to a predetermined set number of bidder accounts, wherein the electronic auction session is configured to initiate after each bidder account of the set number of bidder accounts has committed to the electronic auction session;
sending a debit message for the first bidder account from the bidder device to the auction server, where the debit message configures the auction server to debit real world currency from the first bidder account in accordance with an entry price upon the initiating of the electronic auction session, wherein the auction server is configured to debit each bidder account by the entry price upon the initiating of the electronic auction session;
receiving a start quantity of bids message for the first bidder account at the bidder device from the auction server, wherein the start quantity of bids message comprises information concerning a start quantity of at least one bid ascribed to each bidder account upon commitment to the electronic auction session; and
receiving an initiation notification message for the first bidder account at the bidder device from the auction server, wherein the initiation notification message indicates that the electronic auction session is initiated upon achievement of an elapsed time.

43. The method of claim 42, comprising receiving a winner message for the first bidder account at the bidder device from the auction server, wherein the winner message indicates that the first bidder account has used a winning bid with a bid price that is the lowest unique bid price above a minimum bid price.

44. The method of claim 42, comprising receiving a winner message for the first bidder account at the bidder device from the auction server, wherein the winner message indicates that the first bidder account has used a winning bid with a bid price that is the highest unique bid price below a maximum bid price.

45. The method of claim 42, comprising receiving a winner message for the first bidder account at the bidder device from the auction server, wherein the winner message indicates that the first bidder account has used a winning bid with a bid price that is the highest duplicate bid price at or below a maximum bid price.

46. The method of claim 42, comprising receiving a winner message for the first bidder account at the bidder device from the auction server, wherein the winner message indicates that the first bidder account has used a winning bid with a highest bid price among each bid used prior to the end of the electronic auction session.

47. The method of claim 42, comprising receiving a bid price message for the first bidder account at the bidder device from the auction server, wherein the bid price message indicates a bid price for bids used during the electronic auction session for the set number of bidder accounts after an end of the electronic auction session.
